(19) United States
(12) Patent Application Publication
(10) Pub. No.: US 2006/0161491 A1
(43) Pub. Date: Jul. 20, 2006

(54) Method and system for advertising on credit cards affiliated with sports leagues

(75) Inventor: Andrew Franzone, New York, NY (US)

Correspondence Address: MILBANK, TWEED, HADLEY & MCCLOY, 1 CHASE MANHATTAN PLAZA, NEW YORK, NY, 10005-1413, US

(73) Assignee: Andrew T. Franzone, LLC

(21) Appl. No.: 11/332,451

(22) Filed: Jan. 13, 2006

Related U.S. Application Data
(60) Provisional application No. 60/644,910, filed on Jan. 19, 2005.

(51) Int. Cl. G06Q 40/00

(52) U.S. Cl. 705/35

(57) ABSTRACT

A customer receives a finance card and uses the card to purchase goods and/or services. Based on data compiled from the customer's use of the card the customer is offered an exclusive finance card and offered exclusive products or exclusive services.

This application claims priority to U.S. Provisional Patent application Ser. No. 60/644,910, filed Jan. 19, 2005, entitled METHOD AND SYSTEM FOR ADVERTISING ON CREDIT CARDS AFFILIATED WITH SPORTS LEAGUES, the disclosure of which is incorporated herein by reference.

### BACKGROUND

1. Field of the Invention

The invention relates to the field of credit cards, and more particularly to the field of advertising on credit cards.

2. Description of the Related Art

Credit card products with rewards programs are known in the art. It is known for credit card products to be co-branded with sports leagues. It is also known for credit card companies to advertise their own corporate logos on the credit cards they issue customers, as well as to allow other forms of advertising on the credit cards they issue customers.

If a credit card product is co-branded with a sports league, and the rewards program includes companies who are sponsors in the same sports league, what is needed are systems and methods for regulating how corporate identifiers of these sponsors can be advertised on the credit cards, as well as on various other exclusive products and services which customers can receive.

The preceding description is not to be construed as an admission that any of the description is prior art relative to the invention.

### SUMMARY OF THE INVENTION

In one embodiment, the invention provides a method and system for advertising on finance cards. The method and system comprises issuing at least one finance card to a customer under an original agreement, and compiling information on use of the at least one finance card by the customer. The method and system further comprises determining from the information on use whether the customer is approved to receive an exclusive finance card, and determining from the information on use whether the customer is approved to receive exclusive products or exclusive services. The method and system further comprises responsive to determining whether the customer is approved to receive an exclusive finance card, offering an exclusive finance card to the customer under the original agreement, wherein the exclusive finance card includes an exclusive design. The method and system further comprises responsive to determining whether the customer is approved to receive exclusive products or exclusive services, offering an exclusive product or an exclusive service to the customer.

The specific objects and advantages of the invention described herein are illustrative of those which can be achieved by the present invention and are not intended to be exhaustive or limiting of the possible advantages that can be realized. Thus, the objects and advantages of this invention will be apparent from the description herein or can be learned from practicing the invention, both as embodied herein or as modified in view of any variations which may be apparent to those skilled in the art. Accordingly, the present invention resides in the novel parts, constructions, arrangements, combinations and improvements herein shown and described.

### BRIEF DESCRIPTION OF THE DRAWINGS

The features and other aspects of the invention are explained in the following description taken in conjunction with the accompanying figures wherein:

FIG. 1 illustrates a system according to an embodiment of the invention;

FIG. 2 illustrates steps in a method according to the prior art; and

FIG. 3 illustrates steps in a method according to an embodiment of the invention.

It is understood that the drawings are for illustration purposes only and are not limiting.

### DETAILED DESCRIPTION OF THE DRAWINGS

In the various embodiments described below, the methods and systems provide an opportunity for a credit card company to regulate advertising on credit cards and various other exclusive products and services. In one embodiment, the customer applies for, and is approved to use a credit card which fits two criteria: 1) the credit card is co-branded with a sports league, and 2) the credit card's rewards program includes companies who are sponsors of the same sports league and league entities. As with most credit card products, the customer uses his credit card, and over the course of time accrues and redeems rewards in the rewards program. The credit card issuer compiles a database of information containing the customer's activity, standing, and transaction history in the rewards program. The credit card company uses this database of information to regulate which customers are approved to receive corporate identifiers of sponsors on their credit cards, as well as various other products and services.

Further details and descriptions of these and other embodiments are provided below.

An Example System

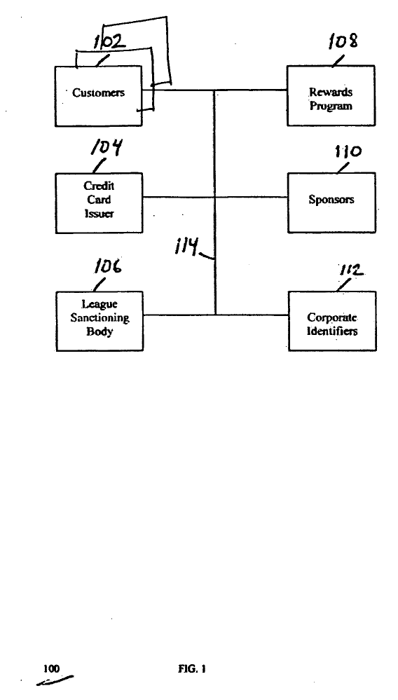

Referring to FIG. 1, an example of one embodiment of system 100 according to the invention includes customers 102, credit card issuer 104, league sanctioning body 106, rewards program 108, sponsors 110, and corporate identifiers 112. Some or all of customers 102, credit card issuer 104, league sanctioning body 106, rewards program 108, sponsors 110, and corporate identifiers 112 have or use computers with central processors, volatile or non-volatile memory, input/output devices, fixed and removable software code storage media, display devices and network connection devices. The individual network connection devices with network 114 provide a wired or a wireless connection among customers 102, credit card issuer 104, league sanctioning body 106, rewards program 108, sponsors 110, and corporate identifiers 112.

Customer 102 is a person, business, or entity eligible and approved to receive a credit card, and may include a person, business, or entity with a particular sports league affiliation, or with no particular league affiliation. Credit card issuer 104 is intended to be a broad term, and examples include a traditional consumer finance firm, as well as other financial entities which may operate, manage, or facilitate credit card products, credit card operations, or electronic payment networks which credit card products use. Examples include, but are not limited to commercial banks, savings banks, credit unions, retail banks, investment banks, brokerage firms, mortgage companies, and membership associations of numerous financial institutions. Credit card issuer 104 may be a financial division of a sports league sanctioning body, a sports league sponsor, or a non-league entity. Credit card issuer 104 may also be a part of a consortium of league entities or non-league entities. League sanctioning body 106 may include sporting event coordinators, owners, rule-makers, commissioning bodies, organizers, and promoters. Rewards program 108 is intended to be a broad term, and may include the network of companies from which customer 102 may accrue or redeem rewards; any commerce network/sales medium which hosts rewards program transactions, or which enables rewards program transactions to take place; any cash-based rewards which customer 102 earns from transactions involving his credit card; any non-monetary units or amounts which customer 102 can accrue or redeem, including points, miles, or other non-monetary terms whose value may be unlocked either into cash or non-cash products and services; or any products or services which customer 102 may receive (or pay for) as a result of cash or non-cash rewards he redeems or exchanges with system 100. Sponsors 110 may be sponsors of the league, league facilities, league media partners, individual participants, individual teams, groups of many individuals who participate as one team or participant in a sports competition, or any other entities, facilities, equipment, or people related to a sports league. Corporate identifiers 112 is intended to be a broad term, and may include a sponsor's name, logo, slogan, emblem, sound clip, picture, likeness, or scent. Corporate identifiers 112 may also include any other trait, feature, image, appearance, or defining characteristic of a sponsor.

It is envisioned that an entity may have more than one function or responsibility in system 100. For example, sponsor 110 may also be customer 102.

Example Methods

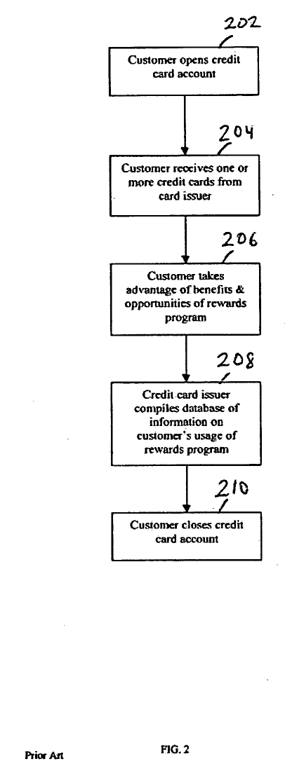

Referring now to FIG. 2, an example process, without the invention, is illustrated. At step 202, customer 102 applies to open a new account for a credit card product which is co-branded with league sanctioning body 106, and whose rewards program 108 generally incorporates companies which are sponsors 110 in the same sports league with which the credit card is co-branded.

Customer 102 signs a credit card agreement with credit card issuer 104, and customer 102's account is approved by credit card issuer 104, subject to numerous credit parameters which credit card issuer 104 assigns to customer 102. The specifics of the credit parameters are not particularly relevant to the invention. Examples of credit parameters include a credit limit, a cash advance limit, a minimum monthly payment, and other parameters which relate to the dollar limit, the interest rate, the fees, and the timeframe of the credit line, the payment schedule, and the general account features and services.

At step 204, credit card issuer 104 provides one or more credit cards for customer 102 to use.

Credit card issuer 104 may or may not allow customer 102 to pick the look of the one or more cards customer 102 receives. For example, credit card issuer 104 may determine the look of the card(s) based on the specifics of the account customer 102 sets up, including such factors as the amount, type, and nature of the credit limit, the payment guidelines, the rewards program, the account features, and any other factors, including the point in time the account was opened.

Alternatively, credit card issuer 104 may allow customer 102 to choose or customize the look of the one or more credit cards customer 102 receives. In particular, customer 102 may specify that on either the front or back of his card(s), he would like there to be various images, pictures, names, or other corporate identifiers 112 of credit card issuer 104, participants, teams, league facilities, league venues, league sanctioning body 106, sponsors 110, other sports league entities, and even non-sports league entities.

At step 206, customer 102 takes advantage of the benefits, features, and opportunities of rewards program 108.

At step 208, credit card issuer 104 compiles a database of information on customer 102's usage, activity, and standing in rewards program 108. In particular, credit card issuer 104 may track the type, amount, timing, and frequency of rewards which customer 102 accrues and redeems; the specific vendors and companies from which customer 102 accrues and redeems rewards; and any other factors or data which may be used to judge customer 102's performance, activity, or standing in rewards program 108.

At step 210 customer 102 may shut down or close his credit card account with card issuer 104 as long as customer 102 has fulfilled all the obligations outlined in the credit agreement by which he is bound.

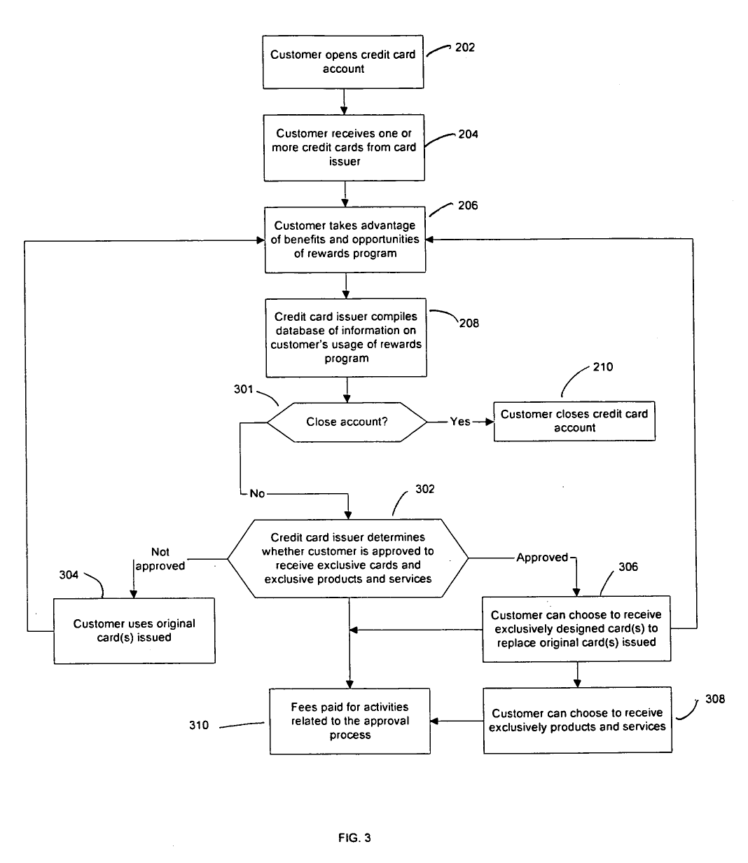

Referring now to FIG. 3, an embodiment of the invention is illustrated. In the figures, steps that are the same or substantially the same as FIG. 2 are identified with the same numbers. In particular, steps 202, 204, 206, 208, 210 of FIG. 3 are the same or substantially the same as illustrated in FIG. 2, and described above.

After credit card issuer 104 compiles a database of information at step 208, then at step 301, system 100 determines whether customer 102 wants to close the account, and if so, the account is closed at step 210.

If the customer does not want to close the account, then at step 302, credit card issuer 104 uses the database of information compiled in step 208 to approve certain customers 102 who are eligible to receive exclusive credit cards and other exclusive products and services. In particular, the exclusivity of these credit cards and other products and services stems from the fact that the cards have incorporated into them at least one or more corporate identifiers 112 of sponsors 110. The term incorporated is intended to be a broad term and may include corporate identifiers that are fixed on, printed on, embedded in, stuck on, or somehow other attached, included, or part of the exclusive cards and the exclusive products and services.

The following are some examples which describe how credit card issuer 104 may use the database of information to determine whether customers are eligible to receive exclusive cards and exclusive products and services. In one example, credit card issuer 104 may approve customer 102 to receive the corporate logo of a particular sponsor on his card once customer 102 has accrued at least 500 points from that same particular sponsor in one calendar year in rewards program 108. To see how this works, if one particular customer 102 (“customer A”) accrues 4,000 points in one calendar year in rewards program 108, but customer A arrives at this 4,000 points figure by accruing 400 points from 10 different sponsors, customer A would not be approved to receive corporate logos from any of these sponsors on his card (since he didn't accrue 500 points in one calendar year from one particular sponsor). On the other hand, if another customer 102 (“customer B”) accrues 2,000 points in one calendar year, but customer B arrives at this 2,000 points figure by accruing 1,000 points from two different sponsors, customer B would be approved to receive an exclusive card. Printed on this exclusive card would be the corporate logos of one or both of the two sponsors from which customer B had accrued 1,000 points. In other embodiments of these examples, credit card issuer 104 may approve customer 102 to receive any corporate identifiers 112 on his card, and not just a corporate logo.

In other examples, credit card issuer 104 may approve customer 102 to receive exclusive cards (and various other products and services) based on any type of threshold or milestone which credit card issuer 104 can use to judge customer 102's standing, performance, or activity in rewards program 108, as compiled by the database of information collected in step 208. For example, instead of requiring 500 points in one calendar year from one sponsor (the approval threshold in the above examples), customer 102 may be required to accrue 100 points in one month from one particular sponsor 110, or 100 points in each of two successive months from one particular sponsor 110. In another example, for every 5,000 total points customer 102 accrues in rewards program 108, regardless of the manner these points are accrued, and regardless of the specific sponsors 110 from which these points are accrued, customer 102 may be approved to receive one corporate logo of any sponsor of his choice on his card, regardless of whether the sponsor chosen may be one of the sponsors 110 from which customer 102 accrued rewards points. In another example, instead of basing the approval on points that are accrued, credit card issuer 104 may base the approval on points that are redeemed. For example, customer 102 may be required to redeem at least 10,000 points in one calendar year in order to receive an approval of some sort. In another example, customer 102's approval may not be based on points, but rather on cash-based or dollar-based thresholds which customer 102 attains in rewards program 108. For example, customer 102 may be required to earn $50 of cash-back rewards in one calendar year from one sponsor to be approved to receive a card with this same sponsor's logo on the card. In another example, customer 102 may be required to use his credit card to pay for at least $500 worth of products and services from one sponsor in one year in rewards program 108. In this scenario, once customer 102 has completed $500 of transaction value from one sponsor, regardless of how many points he accrues for these transactions, customer 102 will be approved to receive printed on his card the logo of the sponsor from which he completed transactions worth $500 or more.

In other embodiments, customer 102's approval may be subject to various conditions and restrictions. For example, if customer 102 has been approved to receive a card with the logos of six different sponsors printed on it, credit card issuer 104 may require that customer 102 accrue at least 100 points from each of these six sponsors in the next calendar year, or else lose his original approval for any of these six sponsors from which he doesn't accrue the requisite 100 points in the following year. In the event customer 102 only receives 100 points from one of these six sponsors in the following year, credit card issuer 104 may take away customer 102's approval to receive a card with six sponsor's logos on it, and reduce the approval to only one sponsor's logo (where the one sponsor is the sponsor from which he received 100 points in the calendar year following the original approval). In another embodiment, credit card issuer 104 may assign an expiration date to any approval it extends to customer 102. For example, credit card issuer may say that all approvals expire one year after they are received.

In one embodiment, credit card issuer determines one or all of the approvals in step 302. In another embodiment, sponsors 110, as well as any other entities in system 100 may determine one or all of the approvals, and credit card issuer 104 may simply determine when customer 102 reaches these approval thresholds based on the database of information it has collected in step 208.

If system 100 determines at step 302 that customer 102 does not receive any approvals, then at step 304, customer 102 continues to use the original card(s) he has been issued at step 204, and customer 102 continues to make use of the rewards program 108 at step 206.

If at step 302 customer 102 receives one or more approvals, then at step 306, customer 102 is eligible to receive one or more exclusive credit cards with corporate identifiers 112 incorporated into them; and at step 308, independent of customer 102's decision to obtain an exclusive card at step 306, (assuming customer 102 has received one or more approvals at step 302), customer 102 is eligible to receive one or more exclusive products and services with corporate identifiers 112 incorporated into them.

At step 306, customer 102 may choose to have credit card issuer 104 provide him with a newly-printed exclusive card, where incorporated into the card are any or all of the corporate identifiers 112 for which customer 102 has been approved to receive at step 302. In one embodiment, customer 102 may decide to receive an exclusive card, where printed on the card are all of the corporate logos of sponsors for which he has been approved at step 302. In another embodiment, customer 102 may decide to receive an exclusive card, where printed on the card are only one or some of the corporate logos of sponsors for which he has been approved at step 302. In a further embodiment, in the event customer 102 uses one or more cards for his account, customer 102 may decide to receive any or all of the corporate identifiers on any or all of his cards he uses, where the choice for each card may be different. In further embodiments, customer 102 may be able to receive exclusive cards whenever he wants, or potentially on selected dates, such as once a year on January 1^{st}.

In a further embodiment, at step 306, even if approved to receive a new card, customer 102 may decide not to receive an exclusive card for which he has been approved, and instead continue to make use of the rewards program at step 206 with the original card he was issued at step 204.

If customer 102 receives one or more approvals at step 302, and at step 306, customer 102 decides to receive one or more new cards, then customer 102 uses the new card(s) in place of the original cards he was issued at step 204, and customer 102 continues to make use of the rewards program at step 206.

At step 308, similar to the embodiments described above for step 306, customer 102 may choose to have credit card issuer 104, or any other entity in system 100, provide him with one or more exclusive products and services, where incorporated into these products and services are one or more of any or all of the corporate identifiers 112 for which customer 102 has been approved at step 302. These exclusive products and services will generally include sports equipment related to the sports league, such as tennis rackets, golf clubs, and racing helmets; as well as apparel, such as hats, t-shirts, and jackets. For example, customer 102 may choose to have credit card issuer 104 provide him with an exclusive t-shirt, where the t-shirt's exclusivity stems from the fact that printed on the t-shirt are all of the corporate logos of the sponsors 110 for which he has received approval at step 302. In another example, if sponsor 110 is a manufacturer of soccer balls, customer 102 may purchase from sponsor 110 a new soccer ball which has printed on it all the logos of sponsors 110 for which he has received approval at step 302.

In one embodiment, at steps 306 and 308, credit card issuer 104, or any other entity in system 100, may make it a free service for the sponsors whose corporate identifiers are incorporated into the exclusive cards, as well as the exclusive products and services, thus giving these sponsors free advertising opportunities. In another embodiment, at steps 306 and 308, credit card issuer 104, or any other entity in system 100, may make it a free service for customer 102 to receive exclusive cards, as well as exclusive products and services.

In another embodiment, at step 310, payments between entities in system 100 may take place.

In one embodiment, credit card issuer 104 may allow customer 102 to buy an approval in place of actually earning the approval through his usage, performance, standing, or activity in rewards program 108. For example, if customer 102 accrues only 200 points in one calendar year in rewards program 108, credit card issuer 104 may allow customer 102 to pay $5 in order to receive an approval which normally would be free if customer 102 had accrued 500 points in one calendar year in rewards program 108.

Customer 102 may also pay to receive the exclusive cards, as well as the exclusive products and services. For example, customer 102 may have to pay credit card issuer 104 an amount of $1 per year for each logo which customer 102 has printed on his exclusive debit card, even if customer 102 has attained the requisite approvals to receive these logos at step 302, and customer 102 is not buying the right to receive these logos in place of hitting the requisite approvals (as is described in the above example where customer 102 buys the approval for $5 in place of attaining the approval through his own contribution, performance, or activity in rewards program 108).

Entities in system 100 may also pay fees to other entities in system 100 for the right or privilege to use corporate identifiers, or have their corporate identifiers incorporated into the exclusive cards, as well as the exclusive products and services. For example, credit card issuer 104 may pay a particular sponsor 110 a fee of $1 a year for each card which credit card issuer 104 prints with sponsor 110's corporate identifier on it. In a further embodiment, a particular sponsor 110 may pay credit card issuer 104 a fee of $1 a year for each card that credit card issuer 104 offers with sponsor 110's logo printed on it.

Having described various embodiments of the system and method of the invention, it is helpful to understand some of the advantages of the invention.

By regulating which customers can and cannot receive corporate logos of sponsors based on performance, activity, or standing in the credit card rewards program, credit card firms can entice customers to use their credit cards more often than they normally might. Sponsors can entice fans to be more brand-loyal to their products and services. Sponsors also have new forms of visual advertising space to reach fans. Fans also have an incentive to earn numerous approvals, and thus receive exclusive cards, as well as other products and services which show their brand-loyalty to the credit card issuer and the sponsors.

Although illustrative embodiments have been described herein in detail, it should be noted and will be appreciated by those skilled in the art that numerous variations may be made within the scope of this invention without departing from the principles of this invention and without sacrificing its chief advantages.

In one embodiment, the credit card is not co-branded with a sports league, but instead is somehow closely affiliated with league sanctioning body 106, such as through an exclusive marketing arrangement, or through some category exclusivity. In the event the credit card is neither co-branded with league sanctioning body 106, nor affiliated with league sanctioning body 106 in some other type of close affiliation, as discussed above, the credit card may still be considered to be affiliated with the sports league if the companies included in its rewards program are limited to only those companies which are sponsors of the sports league or league entities.

In another embodiment, the card is not a traditional rectangular plastic card, but rather is a different shaped card, or some other device or instrument which customer 102 may use in place of a traditional plastic card to communicate account information. Examples of devices and instruments generally include cell phones, pagers, personal digital assistants, watches, laptops, portable music devices, and various other portable consumer electronic instruments which may communicate account information. It is envisioned that if a card is not used, and some other device or instrument is used to communicate account information, customer 102 may not actually receive a new device or instrument, but rather have his credit card information loaded into, saved on, or bundled into an existing device or instrument. In these instances where an instrument or device is used in place of a traditional plastic card, the corporate identifiers 112 may be incorporated into the instruments and devices.

It is also envisioned that at step 302, approvals may be granted specifically for credit cards, as well as specifically for exclusive products and services. For example, credit card issuer 104 may approve customer 102 to receive a corporate logo of a specific sponsor printed on a credit card, but not printed on a t-shirt.

Although not specifically illustrated, it is also envisioned that steps may be combined from different figures, some steps may not be performed, and steps may be added.

Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

I claim:

1. A method for advertising on finance cards, the method comprising:
issuing at least one finance card to a customer under an original agreement;
compiling information on use of the at least one finance card by the customer;
determining from the information on use whether the customer is approved to receive an exclusive finance card;
determining from the information on use whether the customer is approved to receive exclusive products or exclusive services;
responsive to determining whether the customer is approved to receive an exclusive finance card, offering an exclusive finance card to the customer under the original agreement, wherein the exclusive finance card includes an exclusive design; and
responsive to determining whether the customer is approved to receive exclusive products or exclusive services, offering an exclusive product or an exclusive service to the customer.
